(19) United States
(12) Patent Application Publication
(10) Pub. No.: US 2007/0045445 A1
(43) Pub. Date: Mar. 1, 2007

(54) Multi-component fluid spraying system

(76) Inventors: Joseph Hackel, Brookfield, WI (US); Victoria Hackel, Brookfield, WI (US); J. Scott Schmaelzle, Brookfield, WI (US); Steven Raasch, Menomonee Falls, WI (US); David Schwemer, Theresa, WI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/212,195

(22) Filed: Aug. 26, 2005

(51) Int. Cl. A01G 25/09; E01H 3/02

(52) U.S. Cl. 239/146; 239/172

(57) ABSTRACT

A spraying system is provided in which a vehicle engine is used to provide one or more aspects of the system. The vehicle generally includes a box, which can be used in transporting apparatus that facilitates the spraying operation of the system. As such, the vehicle engine can serve a dual purpose. The vehicle engine can be used to power the vehicle, enabling transport of the apparatus via the box, and can be used to provide one or more aspects of the system.

### FIELD

The present invention relates to systems and methods used for spraying fluids and more particularly, for spraying multi-component fluids.

### BACKGROUND SECTION

Multi components are typically liquids which are chemically inert in their respective individual states, and chemically active when brought together and mixed to form a composite liquid mixture. In the chemically active state, such mixed liquids, commonly comprising (i) a resin component and (ii) a catalyst component, are characterized in that they require only a short time interval to become “set” or to solidify. Once such liquids have become solidified they are capable of providing advantageous coatings in the coating materials field, or of providing other advantageous chemical and physical behavior in other fields, depending upon the nature and type of materials being used. For example, such materials are used to provide foam insulation on construction projects, extremely durable finishes on metals and other materials, and unique filling and packing materials for furniture, packaging, and other purposes.

When multi-component liquids are to be applied, there are several ways that the multi components may be combined. For example, the multi components may be applied sequentially. This method of combining the components requires more than one pass across the substrate and may require a separate spray applicator for each individual component. Using this method, the components are not mixed prior to contact with the substrate, but rather applied in layers. Another method of combining multi-component fluids is to mix the multi components prior to their application to the substrate. Using this method, the components may be mixed either before they leave the spray applicator or after they leave the spray applicator, but before reaching the substrate.

There are a variety of ways one can mix and subsequently dispense the multi materials. One traditional low technology way is commonly known as hot potting. In hot potting, the user merely pours the desired amounts of the two (or more recently three) components into a container, mixes them and then sprays or otherwise applies the material to a substrate. In addition to the mess involved in doing so, such use often results in inaccurate mixing and wasted material as often the total amount of material mixed is not utilized.

Over the years, mechanical proportioners, or mechanical pumps, were designed to provide advancements to the archaic hot potting method. Using these pumps, one was able to extract the multi materials from separate drums and mix them prior to spraying. Unfortunately, such mechanical proportioners initially provided no monitoring functions and often lacked the flexibility in adjusting the ratios and the types of material that could be metered and applied. As their development evolved, the proportioners were incorporated with counters to provide such a monitoring function (e.g., via counting the strokes or cycles of the pumps). Additionally, proportioners were designed in which the ratios and types of materials applied could be adjusted. An example of one such mechanical proportioner with these functions is the HYDRA-CAT®, commercially available through Graco Inc., located in Minneapolis, Minn., U.S.A.

In recent years, electronic proportioners, or electronic pumps have been designed to be used instead of or in combination with such mechanical proportioners to overcome any shortcomings of their mechanical counterparts. One such shortcoming is adequate heating of the hoses stemming from the mechanical proportioners. As such, some electronic proportioners have been equipped with high output heaters, used to keep the multi materials in the hoses at a desired viscosity prior to spraying. An example of one such electronic proportioner is the REACTOR™, also commercially available through Graco Inc. In turn, these electronic pumps have been able to provide this heating function more consistently and adequately than the mechanical versions; however, they have tended to be relatively more expensive due to the expensive fluid meters involved.

Such electronic proportioners, while considered an advancement from their mechanical counterparts, have been discovered to have shortcomings. First, they require some sort of separate generator as a power source. If such generator is not supplied with the electronic proportioner, one would need to locate such a power source on the jobsite before the proprotioner could be utilized. Second, transporting an electronic proportioner to a jobsite, carting it from the carrier, if necessary, so that it is generally proximate to the spraying area, and setting it up for spraying can be quite cumbersome. Third, utilizing such electronic proportioners for spraying applications is often costly, due not only to its facilitation of the spraying functionality of the system (e.g., pumping the materials and providing the air for running the spray gun), but also due to its function of heating the materials (while in the hose group leading up to the spray gun) prior to spraying.

Embodiments of the invention are provided to address the above shortcomings as well as others with respect to spraying systems.

### BRIEF SUMMARY

Embodiments of the invention described and illustrated herein teach a spraying system in which a vehicle engine is used to provide one or more aspects of the system. The vehicle generally includes a box, which can be used in transporting apparatus that facilitates the spraying operation of the system. As such, the vehicle engine can serve a dual purpose. The vehicle engine can be used to power the vehicle, enabling transport of the apparatus via the box, and/or can be used to provide one or more aspects of the system.

In certain embodiments of the invention, a system for spraying multi-component fluids is provided. The system comprises a vehicle, an engine located on the vehicle, and apparatus used to facilitate spraying of a multi-component fluid. The engine is used to provide power to the vehicle when the vehicle is driven and is operatively coupled to one or more of the apparatus to provide power to the one or more apparatus.

In certain embodiments of the invention, another system for spraying multi-component fluids is provided. The system comprises a vehicle, an engine located on the vehicle, apparatus used to facilitate spraying of a multi-component fluid, and one or more devices. The engine is used to provide power to the vehicle when the vehicle is driven. The engine has a cooling system. The one or more devices contain engine coolant from the cooling system and are located proximate to one or more of the apparatus to heat material components of the multi-component fluid.

In certain embodiments of the invention, a method of providing a multi-component fluid spraying system is provided. The method has a step for providing a vehicle having an engine, in which the engine is used to provide power to the vehicle when the vehicle is driven. The method has another step for providing apparatus used to facilitate the spraying of a multi-component fluid. The method has a further step of using the engine to do one or more of providing power to one or more of the apparatus and heating material components of the multi-component fluid.

### BRIEF DESCRIPTION OF THE DRAWINGS

FIG. 1 is a perspective view of a vehicle used in providing the spraying system in accordance with certain embodiments of the invention.

FIG. 2 is a block diagram of a spraying system provided by the vehicle of FIG. 1 in accordance with certain embodiments of the invention.

FIG. 3 is block diagram of an another spraying system provided by the vehicle of FIG. 1 in accordance with certain embodiments of the invention.

FIG. 4 is a block diagram of a further spraying system provided by the vehicle of FIG. 1 in accordance with certain embodiments of the invention.

### DETAILED DESCRIPTION

The following discussion is presented to enable a person skilled in the art to make and use the present teachings. Various modifications to the illustrated embodiments will be described and should be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

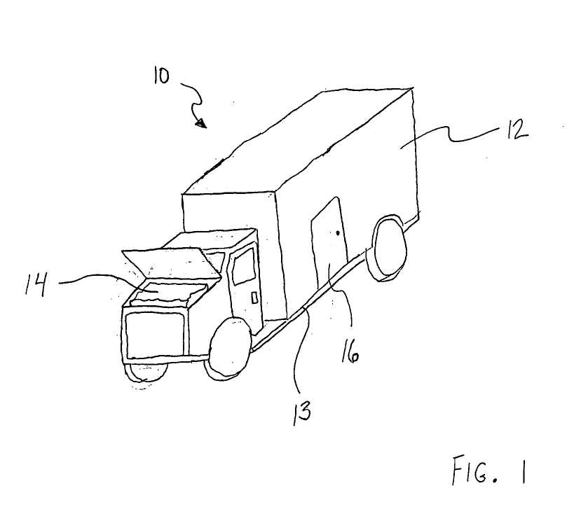

FIG. 1 shows a system in accordance with certain embodiments of the invention. A vehicle 10 having a box 12 is generally shown. The vehicle 10 is used in providing the power equipment and apparatus which enable the spraying of fluids, as detailed herein. The fluids sprayed using such power equipment and apparatus generally involve multi components, such as foam insulation or any other multi product having components that need to be heated prior to spraying; however, the invention should not be limited to such. In essence, by facilitating the power equipment and apparatus via the vehicle 10, the spraying system provided is a complete package. As such, the system is provided as a compact, efficient “spraying factory on wheels”. While the box 12 is generally illustrated in FIG. 1 as being attached to the vehicle 10 with a common chassis 13, the invention should not be limited as such. Other configurations for the vehicle 10 and the box 12 can be used and still be within the spirit of the invention so long as the vehicle 10 and box 12 are able to function together as described herein. For example, the vehicle 10 and box 12 could each have their own chassis (e.g., enabling the box 12 to be a separate unit from the vehicle 10); however, the vehicle 10 and box 12 would still have the ability to be coupled together so as to enable both the functioning of the spraying system (as described herein) and the transport of the box 12 (e.g., via a hitch of the vehicle 10).

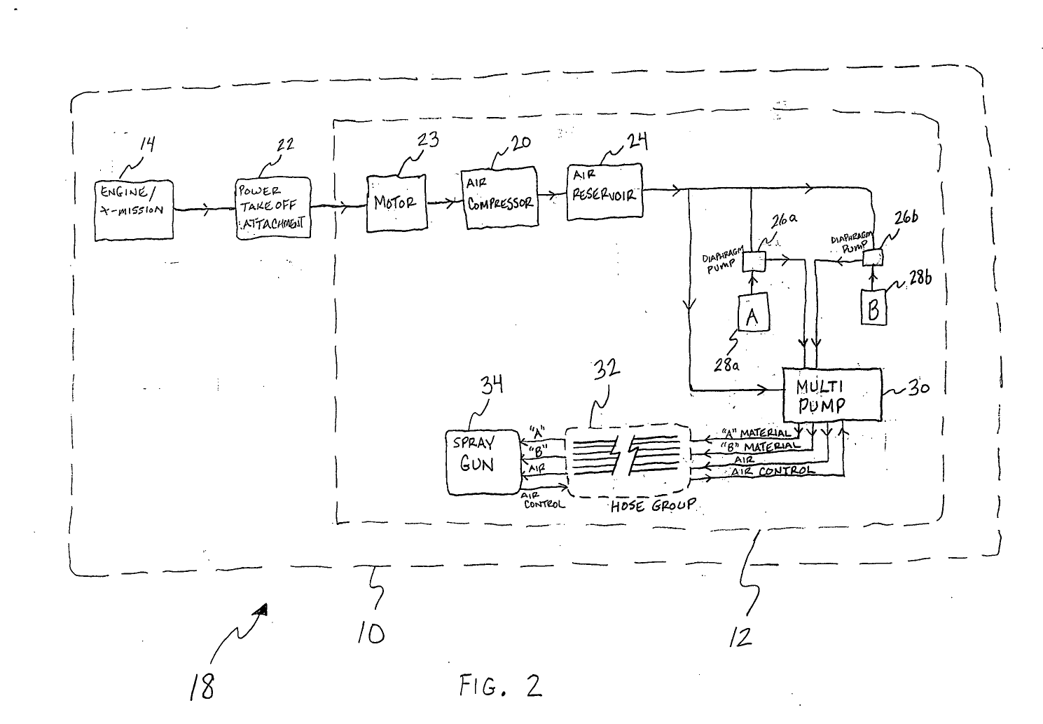

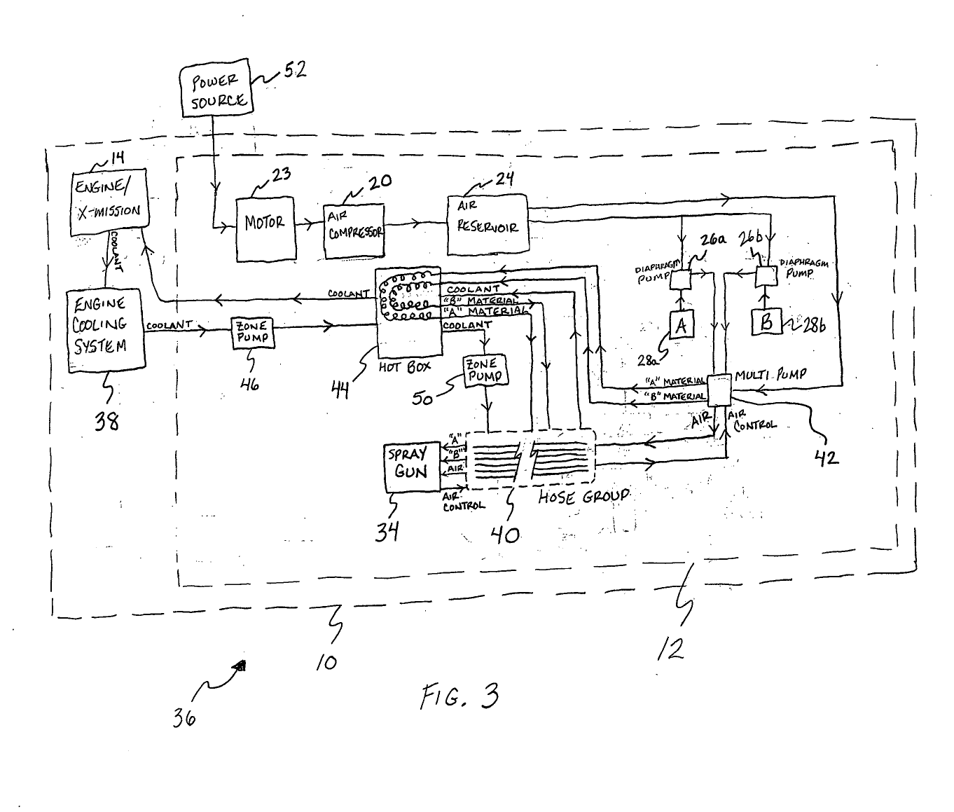

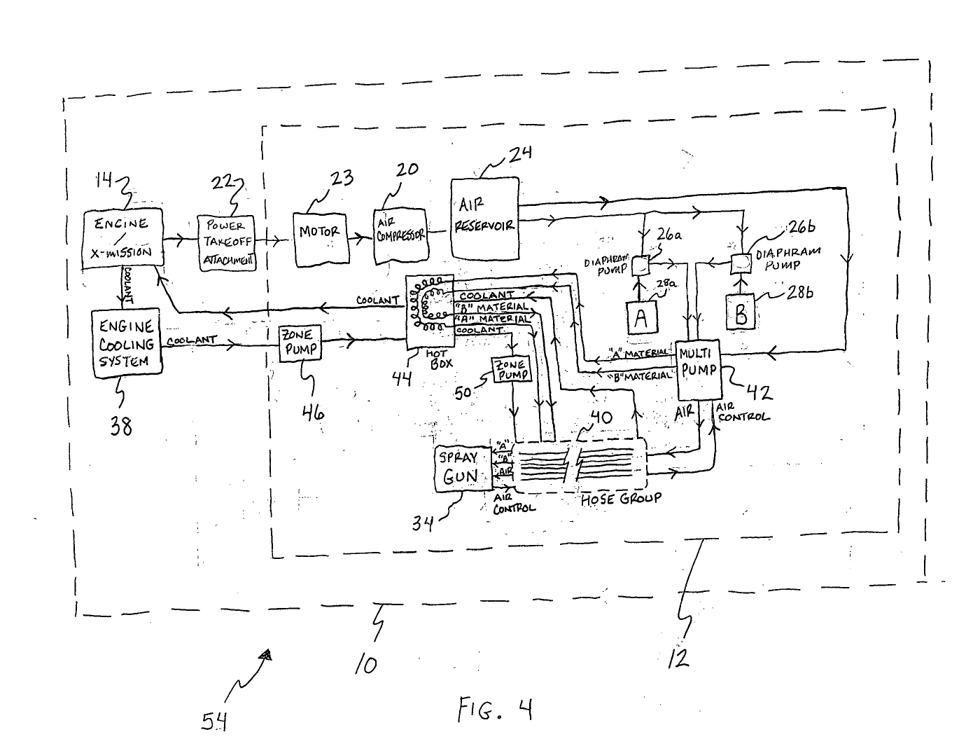

In contrast to other systems, the system facilitated by using both the vehicle 10 and box 12 is found to be superior in a number of ways. For example, in certain embodiments as illustrated in FIG. 2, the system enables the powering equipment to be provided on the vehicle 10, thereby eliminating the need to furnish such powering equipment and/or apparatus after arriving on the jobsite. Additionally, in certain embodiments as illustrated in FIGS. 2 and 4, the system enables the apparatus that powers the spraying equipment to be kept on the vehicle, thereby eliminating the need to initially transport and subsequently remove and cart such apparatus to the spraying area for use. In fact, in certain embodiments as illustrated in FIGS. 2-4, the only components that need to be removed from the box 12 are the hose group and spray gun (neither the hose group nor the spray gun are visibly shown in FIG. 1, but both are referenced in FIG. 2 as 32 and 34 respectively and in FIGS. 3 and 4 as 40 and 34 respectively) to begin spraying. Additionally, in certain embodiments, when the vehicle 10 and box 12 are provided as illustrated in FIG. 1, the system offers ease of maneuverability in tight and sometimes harsh conditions (e.g., muddy or snowy).

In certain embodiments, the vehicle 10 is a truck. The truck, in certain embodiments, is a “low profile” model. Such “low profile” model can be used to provide the towing capability of the system in a cost-efficient manner; however, the invention should not be limited to such. One example of such a model is a 16,000-18,000 pound GVW (gross vehicle weight) low profile model. The vehicle 10 is generally powered by an engine 14 (e.g., typically located forward of a cab of the vehicle 10). In certain embodiments, the engine 14 is a “turbocharged” engine. Such “turbocharged” engine can be used to provide the powering capability of the system; however, the invention should not be limited to such. One example of such a “turbocharged” engine is a 200 horsepower turbocharged diesel engine. In certain embodiments, the engine 14 has cruise control capability. In certain embodiments, the engine 14 has a cooling system. The box 12 is generally an enclosed trailer. The box 12 can measure any length as needed. For example, in certain embodiments, the box 12 can measure eighteen feet in length; however, the invention should not be limited to any specific dimension. The box 12, in certain embodiments, can provide access for persons to the rear of the box 12, and optionally, through one or more doors 16 located at the sides of the box 12. One or more of the interior surfaces of the box 12 (floor, walls and ceiling) can be insulated to provide an environment that is kept generally stable despite the climate and weather conditions outside the box 12. In certain embodiments, a heater (e.g., 40,000 btu) is also provided within the box 12 to heat the environment inside the box 12 when temperatures outside the box 12 are frigid.

In certain embodiments, one or more aspects of the spraying system are provided using the engine 14 of the vehicle 10. As such, one does not have to rely on a separate electric generator to power the one or more aspects of the system, thereby making the system generally less expensive upfront and cheaper to operate. Also, with the engine 14 being used for the dual purpose of powering the vehicle 10 and powering one or more aspects of the spraying system, in certain embodiments, there is one less component (e.g., a separate generator) of the system that has the potential to break down and cause downtime for the operator (e.g., contractor). However, in certain embodiments, the engine 14 may be used to additionally power a PTO generator usable as a power source for any plug-in equipment that may be used.

In accordance with certain embodiments of the invention, FIG. 2 shows a block diagram, illustrating the power equipment and apparatus of a spraying system 18 which, in certain embodiments, can be provided via the vehicle 10 and box 12 as shown. As illustrated, the power generated from the transmission of the vehicle engine 14 can be used to power an air compressor 20 used to facilitate the spraying operation of the system 18. In certain embodiments, as shown, the engine 14 is equipped with a power take-off attachment 22 (e.g., a pump) that powers the air compressor 20 via a motor 23. In certain embodiments, the motor 23 is a hydraulic motor. The power take-off attachment 22, in certain embodiments, is a gear box with a clutch operatively coupled to the transmission of the vehicle's engine 14. In turn, the transmission powers the gear box when the clutch is activated, powering a hydraulic pump that is connected to the gear box. The hydraulic pump, in turn, circulates hydraulic fluid to the motor 23, which powers or drives the air compressor 20. Various designs of the power take-off attachment 22 are commercially available through a number of suppliers, including Seneca Tank, located in Des Moines, Iowa and the Chelsea Product Division of Parker Hannifin Corporation, located in Olive Branch, Miss. The size of the air compressor 20 is generally chosen based on the spraying needs required of the system. For example, in certain embodiments, the air compressor can be a 46 cfm (cubic feet per minute) model, which is generally found suitable for any variety of spraying jobs; however, it is to be appreciated that the invention should not be limited to such. Such a model is commercially available from Atlas-Copco, located in Stockholm, Sweden. In certain embodiments, the motor is a direct drive unit. As such, problems normally experienced with motors having drive belts (e.g., belts going out of alignment or breaking) are avoided. In certain embodiments, the hydraulic fluid of the system is cooled by means of a radiator (e.g., mounted proximate to the compressor 20) in order to prevent the motor 23 or pumps (e.g., multi pump 30) from overheating or wearing out prematurely.

As mentioned above, the air compressor 20, via an air reservoir 24, runs the equipment used to facilitate the spraying operation of the system 18. As previously described, the size of the air compressor 20 is generally selected so as to facilitate the delivery of more than enough air to operate diaphragm pumps 26a, 26b, which respectively extract materials A and B from drums 28a and 28b, and to operate the multi pump 30 which the diaphragm pumps 26a, 26b feed into. Additionally, the air compressor 20 can be used to deliver air to the air tools (e.g., spray gun 34) and air masks (not shown) worn by the persons spraying the materials. While the embodiments of FIGS. 2-4 provide for two materials (A and B) to be mixed for spraying, it is to be appreciated that embodiments of the invention can be further extended to utilize more than two materials without departing from the spirit of the invention. For example, in certain embodiments, at least three materials may be pumped for subsequent mixing and spraying. In other certain embodiments, a range from three to five materials may be pumped for subsequent mixing and spraying.

As mentioned above, the compressor 20 runs the multi pump 30. The multi pump 30, in certain embodiments, is a 33:1 proportioning pump having a 1:1 bottom end that delivers consistent quantities of material to the hose group 32; however, it is to be appreciated that the size of the pump 30, similar to the size of the air compressor 20, is generally chosen based on the spraying needs required of the system. Such pump exemplified above is commercially available from Graco Inc. The multi pump 30 would be equipped with high output heaters, used to keep the multi materials in the hoses of the hose group 32 at a desired viscosity prior to spraying. In certain embodiments, an air dryer is added to the air line between the air reservoir 24 and the multi pump 30 to effectively eliminate any condensation in the system 18. In addition, in certain embodiments, the pump 30 is equipped with a cycling counter to enable the operator (e.g., the contractor) to monitor the amount of material used on each job site. Such use of a cycling counter also enables the operator to provide job costing and well as job estimating with more accuracy.

While not shown, it is to be appreciated that embodiments of the system could alternatively have the multi pump 30 being hydraulically driven. As such, suitable additions generally known to those skilled in the art would be used to facilitate going from an air reciprocator used in the system to a hydraulic reciprocator. For example, in certain embodiments, the multi pump 30 would be adapted with a fixed volume pressure compensated hydraulic pump, which in turn, would feed a hydraulic reciprocating pump.

As also mentioned above, the compressor 20 runs each diaphragm pump 26a and 26b. Multi-component materials A (kept in material drum 28a) and B (kept in material drum 28b) are respectively pumped by the diaphragm pumps 26a and 26b to the multi pump 30. In certain embodiments, each diaphragm pump 26a, 26b is capable of transferring up to twenty gallons per minute, which is generally about ten times faster than most spraying crews can spray. As such, in use, the diaphragm pumps 26a, 26b are not overworked and provide many years of service. Such pumps 26a, 26b are commercially available from Graco Inc. In certain embodiments, each pump 26a, 26b is equipped with its own pressure gauge and flow adjustor (e.g., regulator) so one can adjust for different viscosities and accurately control the flow to the multi pump 30.

As illustrated in FIG. 2, the multi pump 30 leads to a hose group 32 which leads subsequently to a spray gun 34. In certain embodiments, for each of the component materials A and B extracted from the drums 28a, 28b, the hose group 30 involves a nylon hose. In certain embodiments, each nylon hose is ⅜″ diameter 3300 psi hose (e.g., commercially available from Graco Inc.); however, the invention should not be limited to such. In certain embodiments, each of the hoses of the hose group 30 is enveloped within a closed cell foam insulation jacket so as to stay flexible and keep the hoses properly insulated. In certain embodiments, the insulation jacket is ⅜″ thick. In certain embodiments, the hoses are covered with an abrasion resistant nylon webbed sleeve to protect the hoses of the hose group 30 from day to day wear. Such optional additional coverings provide additional reliability for the hoses of the hose group 30 in comparison to electrically heated hoses; however, such coverings generally add weight and cost to the system 18.

In utilizing the system 18 of FIG. 2, the operator (e.g., the contractor) would generally arrive at the jobsite, leave the vehicle 10 running, shift the vehicle 10 into neutral, activate the cruise control, run the RPM of the vehicle 10 to a fast idle speed (e.g., in certain embodiments, such idle speed is in the range of between about 1300 RPM and 1500 RPM), and set the cruise control to maintain the engine at the desired RPM. In turn, the engine 14 can be used to provide the necessary power to the compressor 20, which as described above, would facilitate the spraying operation of the system 18.

In accordance with certain embodiments of the invention, FIG. 3 shows a block diagram, illustrating the power equipment and apparatus of a spraying system 36 which, in certain embodiments, can be provided via the vehicle 10 and box 12 as shown. As illustrated, the heat generated from the vehicle engine 14 can be used to heat the A and B materials fed into hoses of a hose group 40 via use of a engine cooling system 38 (which is powered by the vehicle engine 14). The A and B materials are heated in a thermostatically controlled closed loop system utilizing the cooling system 38. As such, one can set and control the temperature of the A and B materials. Thus, a multi pump 42 used in the system 36 of FIG. 3 would not need to be equipped with high output heaters used to keep the A and B materials in the hoses of the hose group 40 at a desired viscosity prior to spraying, as previously described with respect to the multi pump 30 of FIG. 2.

As shown in FIG. 3, following their exit from the multi pump 42, the A and B materials are routed through a hot box 44. In certain embodiments, the hot box 44 is coupled to the exterior of the box 12. Upon entering the hot box 44, each of the A and B materials are pumped through long coils of metal (e.g., steel) tubing that are enclosed in a tank that circulates hot engine coolant from the engine cooling system 38. In certain embodiments, the A material (e.g., resin material) is pumped through steel tubing, and the B material (e.g., catalyst component) is pumped through stainless steel tubing. In turn, the A and B materials are heated by the hot coolant prior to their being routed to the hose group 40. In certain embodiments, the hot engine coolant is pumped from the engine cooling system 38 to the hot box 44 via a zone pump 46. In certain embodiments, a thermostat is also provided on the feed line from the engine cooling system 38 to the hot box 44 (e.g., as a part of the zone pump 46) in order to monitor and control the temperature of the coolant. As mentioned above, the hot engine coolant is circulated within the hot box 44. Since the tank of the hot box 44 has a fixed area, the pumping of the coolant into the hot box 44 prompts a continual “change out” of coolant from the hot box 44 back to the engine cooling system 38, thereby assuring the coolant in the hot box 44 stays in the desired temperature range to ensure the heated A and B materials are at their desired viscosity.

Following their exit from the hot box 44, the A and B materials are routed to the hose group 40 and subsequently to the spray gun 34. In certain embodiments, the heat of the A and B materials is further maintained within the hose group 40 by circulating the hot engine coolant through the entire length of the hose group 40. The engine coolant can be routed to the hose group 40 via the hot box 44 (as shown) or the engine cooling system 38. In turn, the coolant is pumped into the hoses of the hose group 40 via a zone pump 50. In certain embodiments, a thermostat is also provided on the feed line from the hot box 44 to the hose group 40 (e.g., as a part of the zone pump 50) in order to monitor and control the temperature of the coolant. This coolant is circulated through a flexible tubing that is run proximate to the hoses of the hose group 40 over about the entire length of the hose group 40 up to the end of the spray gun 34. In certain embodiments, the tubing is ⅜″ in diameter; however, the invention should not be limited to such. The tubing, while flexible, accommodates only so much coolant. As such, continual pumping of the coolant in the tubing prompts a continual “change out” of coolant from the tubing back to the hot box 44 and in turn, the engine cooling system 38, thereby assuring the coolant in the tubing stays in the desired temperature range to ensure the heated A and B materials remain at their desired viscosity.

These methods of heating have been found to impart a deeper, longer-lasting heat to the multi component materials than other heating methods currently used with commercially available electrical equipment. In using the above method of heating, the A and B materials have been found to stay at their optimum spraying viscosity even when the climate in which one is spraying is frigid. Additionally, in using the engine cooling system 38 to heat the materials to be sprayed in the above described fashions, one can conduct the heating of the A and B materials while driving to a job site, enabling work to be started immediately upon arrival. In contrast, if using a separate generator to heat the materials, one must get to the job site and then start the generator to heat the materials before spraying can begin, incurring downtime.

As shown, the apparatus which enables the spraying operation is similar to that already described herein with respect to FIG. 2. A power source 52 (e.g., a generator), remote of the vehicle 10 in certain embodiments, is used to power the air compressor 20. As shown, in certain embodiments, this powering of the air compressor 20 is via the motor 23. The air compressor 20, via the air reservoir 24, runs the equipment used to facilitate the spraying operation of the system 36. As mentioned herein, the size of the air compressor 20 is selected so as to facilitate the delivery of more than enough air to operate the diaphragm pumps 26a, 26b which respectively extract the multi-component materials A and B from drums 28a and 28b and to operate the multi pump 42 which the diaphragm pumps 26a, 26b feed into. Additionally, the air compressor 20 can be used to deliver air to the air tools (e.g., spray gun 34) and air masks (not shown) worn by the persons spraying the materials. The multi pump 42 is similar to the version described with respect to FIG. 2, with the exception that it would not need to be equipped with high output heaters, as mentioned above.

In utilizing the system 36 of FIG. 3, the operator (e.g., the contractor) would generally start the vehicle 10, put the transmission of the engine 14 in neutral, and let the engine 14 run at the job site. In turn, the heat from the hot engine coolant of the engine cooling system 38 can be used to heat the A and B materials fed into the hoses of the hose group 40, which as described above, would facilitate the A and B materials to reach and stay at their optimum spraying viscosity for the spraying system 36.

In accordance with certain embodiment of the invention, FIG. 4 shows a block diagram, illustrating the power equipment and apparatus of a spraying system 54 which, in certain embodiments, can be provided via the vehicle 10 and box 12 as shown. As illustrated, the power generated from the transmission of the vehicle engine 14 can be used to power an air compressor 20 used to facilitate the spraying operation of the system 18. As also shown, the heat generated from the vehicle engine 14 can be used to heat the A and B materials fed into the hoses of the hose group 40 via use of the cooling system 38 (which is powered by the vehicle engine 14). As such, the system 54 illustrated in FIG. 4 represents a partial combination of the systems illustrated in both FIGS. 2 and 3.

The differences between the systems of FIGS. 4 and 2 mainly involve the engine cooling system 38 being used to heat the A and B materials. As such, the multi pump 42 of FIG. 4 (also used in the system 36 of FIG. 3) would not need to be equipped with high output heaters to keep the A and B materials in the hoses of the hose group 40 at a desired viscosity prior to spraying. The differences between the systems of FIGS. 4 and 3 mainly involve the vehicle engine 14 being used to power the air compressor 20. As such, there would not be a need for the power source 52 (illustrated in FIG. 3) to power the air compressor 20.

In utilizing the system 54 of FIG. 4, the operator (e.g., the contractor) would generally arrive at the jobsite, leave the vehicle 10 running, shift the vehicle 10 into neutral, activate the cruise control, run the RPM of the vehicle 10 to a fast idle speed (e.g., in certain embodiments, such idle speed is in the range of between about 1300 RPM and 1500 RPM), and set the cruise control to maintain the engine at the desired RPM. In turn, the engine 14 can be used to provide the necessary power to the compressor 20, which as described above, would facilitate the spraying operation of the system 54. In addition, the heat from the hot engine coolant of the engine cooling system 38 can be used to heat the A and B materials fed into the hoses of the hose group 40, which as described above, would facilitate the A and B materials to reach and stay at their optimum spraying viscosity for the spraying system 54.

It will be appreciated the embodiments of the invention can take many forms. The true essence and spirit of the embodiments of the invention are defined in the appended claims, and it is not intended for the embodiments of the invention presented herein to limit the scope thereof.

1-21. (canceled)

22. A system for spraying multi-component fluids, comprising:
an engine having a cooling system;
apparatus used to facilitate the spraying of a multi-component fluid; and
one or more devices containing engine coolant from the cooling system, the one or more devices located proximate to one or more of the apparatus to heat material components of the multi-component fluids.

23. The system of claim 22, further comprising a vehicle, wherein the engine is located on the vehicle and used to power the vehicle.

24. The system of claim 23, wherein the engine is adapted to provide power to the apparatus.

25. The system of claim 23, further comprising a box, wherein the apparatus is provided in the box.

26. The system of claim 25, wherein the vehicle and the box are connected by a common chassis.

27. The system of claim 25, wherein the vehicle and the box each have separate chassises, enabling the box to be separated from the vehicle, the box comprising an enclosed trailer.

28. The system of claim 22, wherein at least one of the one or more devices is operatively coupled to the engine cooling system in a closed loop configuration.

29. The system of claim 28, further comprising a pump located between the at least one of the one or more devices and the engine cooling system to provide for continual change out of the coolant in the one or more devices.

30. The system of claim 28, wherein the apparatus comprises a plurality of drums each containing one of the material components, a plurality of pumps each adapted to extract one of the material components from one of the drums, a multi pump being fed the material components by the plurality of pumps, a hose group being fed the material components by the multi pump, and a spray gun connected to the hose group.

31. The system of claim 30, wherein the apparatus further comprises a plurality of coils of metal tubing connected between the multi pump and the hose group, and wherein the one or more devices comprises a tank, wherein the tank contains the plurality of coils.

32. The system of claim 30, wherein the one or more devices comprises tubing for the hose group.

33. The system of claim 22, wherein the apparatus is air driven.

34. The system of claim 22, wherein the apparatus is hydraulically driven.

35. A system for spraying multi-component fluids, comprising:
an engine having a cooling system;
apparatus used to facilitate the spraying of a multi-component fluid; and
a closed loop configuration involving engine coolant from the engine cooling system being circulated proximate to one or more of the apparatus to heat material components of the multi-component fluids.

36. The system of claim 35, further comprising a vehicle, wherein the engine is located on the vehicle and used to power the vehicle.

37. The system of claim 36, wherein the engine is adapted to provide power to the appartus.

38. The system of claim 36, further comprising a box, wherein the apparatus is provided in the box.

39. The system of claim 38, wherein the vehicle and the box are connected by a common chassis.

40. The system of claim 38, wherein the vehicle and the box each have separate chassises, enabling the box to be separated from the vehicle, the box comprising an enclosed trailer.

41. The system of claim 35, wherein the closed loop configuration includes a pump located between the closed loop configuration and the engine cooling system to provide for continual change out of the coolant in the closed loop configuration.

42. The system of claim 41, wherein the apparatus comprises a plurality of drums each containing one of the material components, a plurality of pumps each adapted to extract one of the material components from one of the drums, a multi pump being fed the material components by the plurality of pumps, a hose group being fed the material components by the multi pump, and a spray gun connected to the hose group.

43. The system of claim 42, wherein the apparatus further comprises a plurality of coils of metal tubing connected between the multi pump and the hose group, wherein the closed loop configuration comprises one or more devices containing engine coolant from the cooling system, and wherein the one or more devices are located proximate to the plurality of coils.

44. The system of claim 43, wherein the one or more devices comprises a tank, wherein the tank contains the plurality of coils.

45. The system of claim 41, wherein the closed loop configuration comprises one or more devices containing engine coolant from the cooling system, and wherein the one or more devices comprises tubing for the hose group.

46. The system of claim 35, wherein the apparatus is air driven.

47. The system of claim 35, wherein the apparatus is hydraulically driven.

48. A system for spraying multi-component fluids, comprising:
a vehicle;
an engine located on the vehicle, the engine used to power the vehicle;
apparatus used to facilitate the spraying of a multi-component fluid; and
coolant from the engine being used to heat material components of the multi-component fluid.

49. The system of claim 48, further comprising a power attachment operatively coupled between the engine and the one or more apparatus.

50. The system of claim 48, wherein the engine is adapted to provide power to the apparatus.

51. The system of claim 48, further comprising a box, wherein the apparatus is provided in the box.

52. The system of claim 51, wherein the vehicle and the box are connected by a common chassis.

53. The system of claim 51, wherein the vehicle and the box each have separate chassises, enabling the box to be separated from the vehicle, the box comprising an enclosed trailer.

54. The system of claim 48, wherein the engine coolant is circulated proximate to one or more of the apparatus in a closed loop configuration via one or more devices operatively coupled to the engine cooling system.

55. The system of claim 54, further comprising a pump located between the at least one of the one or more devices and the engine cooling system to provide for continual change out of the coolant in the one or more devices.

56. The system of claim 54, wherein the apparatus comprises a plurality of drums each containing one of the material components, a plurality of pumps each adapted to extract one of the material components from one of the drums, a multi pump being fed the material components by the plurality of pumps, a hose group being fed the material components by the multi pump, and a spray gun connected to the hose group.

57. The system of claim 56, wherein the apparatus further comprises a plurality of coils of metal tubing connected between the multi pump and the hose group, and wherein the one or more devices comprises a tank, wherein the tank contains the plurality of coils.

58. The system of claim 56, wherein the one or more devices comprises tubing for the hose group.

59. The system of claim 48, wherein the apparatus is air driven.

60. The system of claim 48, wherein the apparatus is hydraulically driven.
